(19) United States
(12) Patent Application Publication
(10) Pub. No.: US 2023/0261281 A1
(43) Pub. Date: Aug. 17, 2023

(54) HEAT DISSIPATION CUSHION FIRE EXTINGUISHING PAD FOR ELECTRIC VEHICLE BATTERY PACK

(71) Applicant: SPIDERSILK CO., LTD., Seongnam-si (KR)

(72) Inventors: Woong CHOI, Hwaseong-si (KR); Sung Won HA, Anyang-si (KR)

(21) Appl. No.: 17/941,368

(22) Filed: Sep. 9, 2022

(30) Foreign Application Priority Data
Feb. 14, 2022 (KR) 10-2022-0019050

(51) Int. Cl. H01M 10/6555; H01M 10/658; A62D 1/00

(52) U.S. Cl. CPC H01M 10/6555; A62D 1/0021; H01M 10/658; H01M 2220/20

(57) ABSTRACT

Provided is a fire extinguishing pad installed in a battery pack for an electric vehicle, and more particularly, to a heat dissipation cushion fire extinguishing pad for an electric vehicle battery pack that maintains the normal performance of a battery by dissipating heat to the outside when a cell is overheated because of various reasons, delays and suppresses a fire by discharging a fire extinguishing liquid when the fire occurs, and absorbs expansion displacement of a cell by being contracted when the cell is expanded by heat.

### BACKGROUND OF THE INVENTION

### 1. Field of the Invention

The present invention relates to a fire extinguishing pad installed in a battery pack for an electric vehicle, and more particularly, to a heat dissipation cushion fire extinguishing pad for an electric vehicle battery pack that maintains the normal performance of a battery by dissipating heat to the outside when a cell is overheated because of various reasons, delays and suppresses a fire by discharging a fire extinguishing liquid when the fire occurs, and absorbs expansion displacement of a cell by being contracted when the cell is expanded by heat.

### 2. Description of the Related Art

Unlike a gasoline vehicle, an electric vehicle broadly includes a battery, an inverter, which is a power conversion device, and a motor.

The battery is an energy storage device. The power conversion device is a device that converts electrical energy of the battery to generate required driving power. The motor operates by using the electrical energy and moves the vehicle.

The advantage of the electric vehicle is that the electric vehicle is environmental-friendly. However, when a fire occurs because of external impact, an internal short circuit, or the like, the battery is entirely burnt down until the battery is completely burnt.

When the battery cell is on fire, the fire does not go out until the battery cell is completely burnt down. Further, because a capacity and size of the battery are significantly large, there is a likelihood that the vehicle is burnt down. Therefore, it is very important to initially extinguish and suppress the fire when the electric vehicle is on fire.

The battery cells, which are the most basic structures of the battery packs for electric vehicles, are classified into a pouch type battery cell, an angular battery cell, and a cylindrical battery cell. The battery cell is heated and expanded when the battery cell is charged and used.

In the related art, a structure is disposed between the battery cell and the cell and made of urethane foam to absorb expansion displacement when the cell expands. Further, there is a need to dissipate heat from the cell of the battery pack. However, there is no solution related to the dissipation of heat from the cell of the battery pack at present.

There is a need to develop a technology related to the “five-minute delay” required to ensure the escape time for protecting an occupant’s life until the fire is rapidly spread from a point in time at which the fire occurs.

### [Documents of Related Art]

### [Patent Documents]

(Patent Document 0001) Document 1. Korean Patent No. 10-2149439 “BATTERY PACK EQUIPPED WITH FIRE EXTINGUISHING FILM CONTAINING FIRE EXTINGUISHING MICRO-CAPSULE”
(Patent Document 0002) Document 2. Korean Patent No. 10-2123659 “FIRE EXTINGUISHING SHEET COMPRISING MICROCAPSULE FOR FIRE EXTINGUISHING”
(Patent Document 0003) Document 3. Korean Patent Application Laid-Open No. 10-2021-0151647 “FIRE EXTINGUISHING DEVICE FOR SECONDARY BATTERY AND BATTERY PACK CONTAINING THEREOF”
(Patent Document 0004) Document 4. Korean Patent No. 10-2149435 “FIRE EXTINGUISHING FILM COMPRISING MICROCAPSULE FOR FIRE EXTINGUISHING AND PREPARATION METHOD THEREOF”

### SUMMARY OF THE INVENTION

An object of the present invention is to provide a heat dissipation cushion fire extinguishing pad for an electric vehicle battery pack, that may be installed in a vehicle battery pack, maintain the continuous performance of a battery cell by effectively discharging heat generated in a cell, effectively absorb expansion displacement when the battery cell is expanded by heat, and ensure the time for which an occupant may escape by delaying and suppressing a fire by discharging a fire extinguishing liquid when the fire occurs.

According to an aspect of the present invention, a heat dissipation cushion fire extinguishing pad for an electric vehicle battery pack includes: a fire extinguishing cushion layer 110 in which fire extinguishing capsules 111 each having a capsule 112 filled with a fire extinguishing liquid 113 are mixed; and heat dissipation layers 120 having a mixed thermally conductive heat dissipation filler and stacked on upper and lower portions of the fire extinguishing cushion layer 110, in which the heat dissipation cushion fire extinguishing pad is inserted between cells 202 of a battery pack 200, dissipates heat generated in the cell 202, and releases the fire extinguishing liquid 113 to suppress and delay a fire when the fire occurs.

In this case, resin constituting the fire extinguishing cushion layer 110 and the heat dissipation layer 120 may be configured by mixing 0.1 to 5 parts by weight of a photoinitiator and 0.1 to 10 parts by weight of a photocuring agent with 100 parts by weight of an acrylate monomer.

In addition, resin constituting the heat dissipation layer 120 may be configured by further mixing 1 to 50 parts by weight of a viscoelasticity adjusting agent with 100 parts by weight of the acrylate monomer.

In addition, in the fire extinguishing cushion layer 110, 30 to 100 parts by weight of the fire extinguishing capsule 111 may be mixed with 100 parts by weight of the resin.

In addition, cushion bubbles 114 provided in the form of air bubbles or plastic bubbles filled with air may be formed in the fire extinguishing cushion layer 110.

A volume ratio of the cushion bubbles 114 to the fire extinguishing cushion layer 110 may be 1:0.2 to 1.0.

In addition, the heat dissipation filler may be configured by mixing any one or two or more of aluminum hydroxide {Al (OH) ₃}, alumina (Al₂O₃), boron nitride (BN), copper (Cu), aluminum (Al), silver (Ag), carbon fiber, carbon nanotubes (CNTs), graphene, and phase change materials (PCM).

In addition, 50 to 1,500 parts by weight of the heat dissipation filler may be mixed with 100 parts by weight of the resin of the heat dissipation layer 120.

The heat dissipation cushion fire extinguishing pad for an electric vehicle battery pack according to the present invention described above may effectively dissipate heat generated in the cell of the battery pack and release the fire extinguishing liquid when the cell is overheated, thereby suppressing and delaying a fire and minimizing damage to property and human life.

### BRIEF DESCRIPTION OF THE DRAWINGS

FIG. 1 is a perspective view illustrating a heat dissipation cushion fire extinguishing pad according to the present invention.

FIG. 2 is a cross-sectional view illustrating a fire extinguishing capsule constituting a fire extinguishing cushion layer of the pad according to the present invention.

FIG. 3 is a view illustrating a process of manufacturing the heat dissipation cushion fire extinguishing pad according to the present invention.

FIG. 4 is a perspective view illustrating a battery pack in which the heat dissipation cushion fire extinguishing pad according to the present invention is installed.

FIG. 5 is an enlarged view illustrating a state in which cells and the heat dissipation cushion fire extinguishing pads according to the present invention are alternately installed in the battery pack.

FIG. 6 is a view illustrating a state in which the pad according to the present invention absorbs expansion displacement of the cell.

### DETAILED DESCRIPTION OF THE PREFERRED EMBODIMENT

Hereinafter, the present invention will be described in detail with reference to exemplary embodiments of the present invention and the accompanying drawings on the assumption that like reference numerals in the drawings indicate like constituent elements.

In the detailed description of the invention and claims, unless explicitly described to the contrary, when one constituent element “comprises/includes” another constituent elements, this configuration is not interpreted as being limited to a configuration in which only the constituent element is present, but it should be understood that other constituent elements may further be included.

The terms “upper,” “lower,” “bottom,” “front,” “rear,” and “below” used in the present specification are used to facilitate the description and indicate the orientation of the constituent elements illustrated in the drawings.

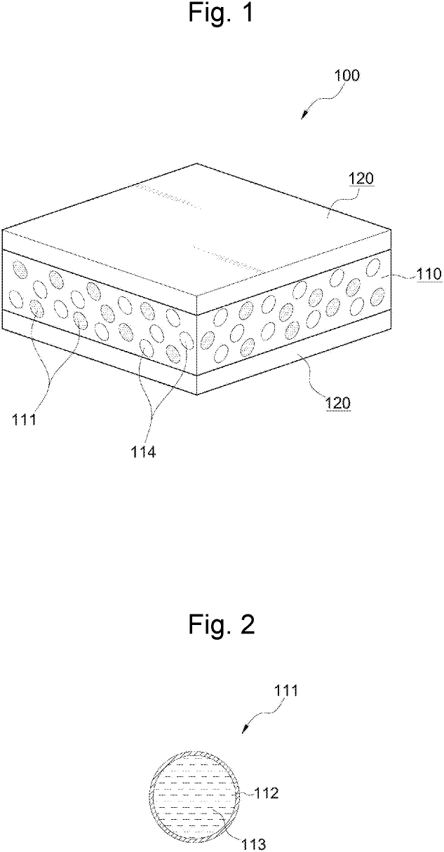

As illustrated in FIG. 1, a heat dissipation cushion fire extinguishing pad 100 according to the present invention includes a fire extinguishing cushion layer 110, and heat dissipation layers 120 stacked on upper and lower portions of the fire extinguishing cushion layer 110.

The fire extinguishing cushion layer 110 serves to absorb expansion displacement when a cell 202 of a battery pack 200 swells. The fire extinguishing cushion layer 110 serves to delay or suppress a fire by discharging a fire extinguishing liquid when the cell 202 is overheated and a fire occurs because of various reasons.

Further, the heat dissipation layer 120 serves to maintain a stable state of the cell 202 by quickly dissipating heat generated in the cell 202 to the outside.

The fire extinguishing cushion layer 110 is positioned at a center of the pad 100 and includes therein fire extinguishing capsules 111 and cushion bubbles 114.

As illustrated in FIG. 2, the fire extinguishing capsule 111 has a capsule 112 filled with a fire extinguishing liquid 113.

The capsule 112 may be formed in a spherical shape and made of non-porous polymer such as epoxy. The capsule 112 may be filled with the fire extinguishing liquid 113 that may be various publicly-known fire extinguishing liquids and widely used as the fire extinguishing liquid such as fluorine compound such as NOVEC™ of 3M.

The cushion bubble 114 may be configured by using a plastic capsule filled with separate air, like the fire extinguishing capsule 111. Alternatively, the cushion bubble 114 may be naturally formed in the fire extinguishing cushion layer 110 as bubbles are formed in resin at the time of blending the resin constituting the fire extinguishing cushion layer 110 and the resin is cured. In addition, air bubbles and the plastic capsules filled with air may be used together.

Because the method of forming bubbles in resin is a publicly-known technology, a detailed description thereof will be omitted.

The fire extinguishing cushion layer 110 is made of acrylic polymer obtained by polymerizing various types of acrylate monomers.

Various types of acrylate monomers include acrylate ((meth)acrylic acid, (meth)acrylic amide, hydroxy alkyl (meth)acrylate, glycidyl (meth)acrylate, etc.) including alkyl (meth)acrylate and the functional group and constitute a polymer matrix.

Additive used to polymerize acrylic polymer include a tackifier (rosin type, terpene type, hydrocarbon type, acryl type, etc.) for adjusting viscoelasticity, a photoinitiator (Irgacure, TPO, Darocure, etc.) for creating an acrylic polymerization reaction, a photocuring agent (typically, multifunctional acrylate, HDDA, TPGDA, TMPTA, DPHA, etc.) for making crosslinking bonding of the polymer matrix, and the like. The fire extinguishing cushion layer 110 is manufactured by combining these materials and performing UV curing on the combined material.

In this case, the fire extinguishing capsules 111 for the fire extinguishing function are put into the fire extinguishing cushion layer 110 and the cushion bubbles for the cushion function are formed.

The resin constituting the fire extinguishing cushion layer 110 is configured by mixing 0.1 to 5 parts by weight of the photoinitiator and 0.1 to 10 parts by weight of the photocuring agent with 100 parts by weight of the acrylate monomer.

In this case, 1 to 10 parts by weight of a viscoelasticity adjusting agent such as the tackifier may be further mixed with 100 parts by weight of the acrylate monomer.

Further, 30 to 100 parts by weight of the fire extinguishing capsule 111 are mixed with 100 parts by weight of the resin of the fire extinguishing cushion layer 110, and the fire extinguishing cushion layer 110 is configured such that a volume ratio of the cushion bubbles 114 to the mixed resin is 1:0.2 to 1.0.

When the fire extinguishing capsule 111 is less than 30 parts by weight with respect to 100 parts by weight of the resin of the fire extinguishing cushion layer 110, the fire extinguishing and fire suppressing functions cannot be appropriately exhibited in the event of a fire on the battery pack. When the fire extinguishing capsule 111 exceeds 100 parts by weight, the amount of resin constituting the fire extinguishing cushion layer 110 is small, and strength decreases. Therefore, 30 to 100 parts by weight of the fire extinguishing capsule 111 may be mixed with 100 parts by weight of the resin.

In addition, the volume ratio of the cushion bubbles 114 to the resin of the fire extinguishing cushion layer 110 is 1:0.2 to 1.0. When the cushion bubbles 114 are less than a volume ratio of 0.2, the cushion bubbles 114 cannot appropriately absorb the expansion displacement of the cell 202. When the cushion bubbles 114 exceed a volume ratio of 1.0, the amount of resin constituting the fire extinguishing cushion layer 110 is small, and strength decreases. Therefore, the volume ratio of the cushion bubble 114 to the resin of the fire extinguishing cushion layer 110 may be 1:0.2 to 1.0.

The heat dissipation layers 120 are stacked on the upper and lower portions of the fire extinguishing cushion layer 110. The heat dissipation layers 120 are in contact with the cell 202 of the battery pack and serve to quickly dissipate heat generated in the cell 202 to the outside.

The resin constituting the heat dissipation layer 120 is made of acrylic polymer obtained by polymerizing various types of acrylate monomers.

Various types of acrylate monomers include acrylate ((meth)acrylic acid, (meth)acrylic amide, hydroxy alkyl (meth)acrylate, glycidyl (meth)acrylate, etc.) including alkyl (meth)acrylate and the functional group and constitute a polymer matrix.

Additive used to polymerize acrylic polymer include a tackifier (rosin type, terpene type, hydrocarbon type, acryl type, etc.) for adjusting viscoelasticity, a photoinitiator (Irgacure, TPO, Darocure, etc.) for creating an acrylic polymerization reaction, a photocuring agent (typically, multifunctional acrylate, HDDA, TPGDA, TMPTA, DPHA, etc.) for making crosslinking bonding of the polymer matrix, and the like. The heat dissipation layer 120 is manufactured by combining these materials and performing UV curing on the combined material.

The resin constituting the heat dissipation layer 120 is configured by mixing 0.1 to 5 parts by weight of the photoinitiator and 0.1 to 10 parts by weight of the photocuring agent with 100 parts by weight of the acrylate monomer.

In this case, 1 to 10 parts by weight of a viscoelasticity adjusting agent such as the tackifier may be further mixed with 100 parts by weight of the acrylate monomer.

Further, a heat dissipation filler is mixed to quickly transfer heat generated in the cell 202 to the outside by conduction.

Aluminum hydroxide {Al (OH) ₃}, alumina (Al₂O₃), or boron nitride (BN) is used as a ceramic-based heat dissipation filler, copper (Cu), aluminum (Al), or silver (Ag) is used as a metal-based heat dissipation filler in the form of powder or filaments, and any one or a mixture of two or more of carbon fibers, carbon nanotubes (CNTs), graphene, and phase change material (PCM) capsules are used as a carbon-based heat dissipation filler.

50 to 1, 500 parts by weight of the heat dissipation filler are mixed with 100 parts by weight of the resin of the heat dissipation layer 120. The reason why the contents of the heat dissipation filler are as wide as 50 to 1, 500 parts by weight is that the density varies depending on the type of heat dissipation filler.

When the heat dissipation filler is less than 50 parts by weight, the heat dissipation effect implemented by the thermal conduction effect of the filler cannot be appropriately exhibited. When the heat dissipation filler exceeds 1, 500 parts by weight, the amount of resin constituting the heat dissipation layer 120 is small, and strength decreases. Therefore, 50 to 1, 500 parts by weight of the heat dissipation filler may be mixed with 100 parts by weight of the resin of the heat dissipation layer 120.

In addition, the phase change material (PCM) having a large heat capacity is mixed with the heat dissipation layer 120, such that the time for which a temperature is maintained without increasing from a particular temperature may be lengthened, and the thermal conduction may occur through the heat dissipation filler for the time, thereby preventing a rapid increase in temperature of the battery cell 202.of the battery cells 111

5 to 50 parts by weight of the phase change material may be mixed with 100 parts by weight of the resin of the heat dissipation layer 120.

When the phase change material is less than 5 parts by weight, the effect is insufficient. When the phase change material exceeds 50 parts by weight, cracks may be easily formed in the heat dissipation layer 120 because of external impact. Therefore, 5 to 50 parts by weight of the phase change material may be mixed with 100 parts by weight of the resin of the heat dissipation layer 120.

One or more materials selected from paraffin (CnH2n₊₂) having the carbon number of 13 to 28, fatty acid (CH₃ (CH₂) ₂nCOOH), and a mixture thereof may be used as the phase change material, the present invention is not limited thereto. The material may be selected depending on the use of composite materials.

The phase change material may control heat by absorbing or dissipating heat while changing in phase between a solid phase and a liquid phase at a particular temperature.

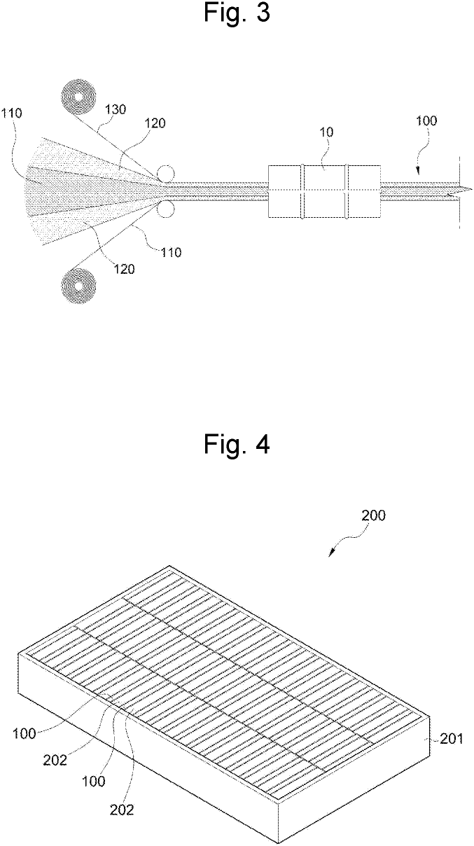

As illustrated in FIG. 3, release paper sheets 130 each having the heat dissipation layer 120 and an adhesive layer are compressed against the upper and lower portions of the fire extinguishing cushion layer 110, and this compressed assembly passes through a UV chamber 10, such that the pad 100 according to the present invention is manufactured. A degree to which the cushion bubbles 114 in the fire extinguishing cushion layer 110 are contracted and expanded in accordance with a pressure may be controlled depending on a degree to which the resin is cured.

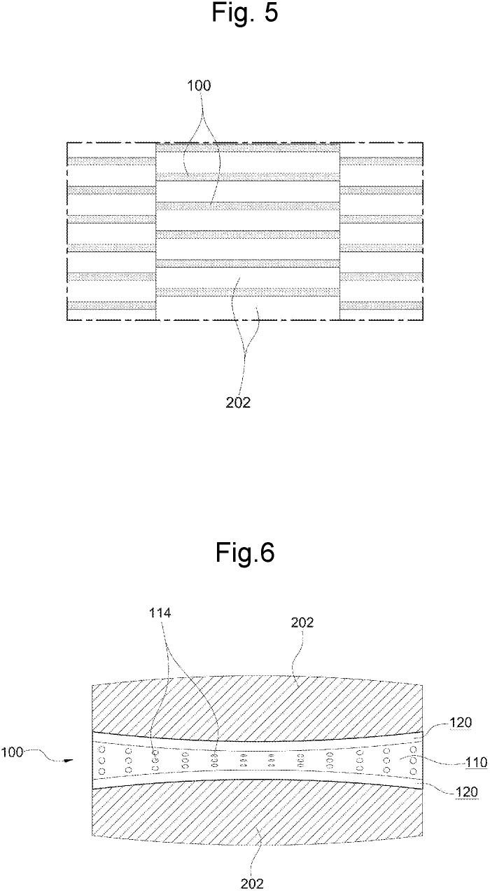

As illustrated in FIGS. 4 and 5, the pad 100 according to the present invention is installed in the battery pack 200, and the pad 100 according to the present invention is inserted between the cells 202.

In this case, the pad 100 is in close contact with the cells 202 by the adhesive layers formed on the pad 100, such that heat generated in the cells 202 may be quickly transferred to the pad 100 by conduction and dissipated.

When the cells 202 expand, the pad 200 according to the present invention, which is installed in the battery pack 200 as described above, absorbs the expansion displacement and allows the cells 202 to stably operate. As illustrated in FIG. 6, when the cells 202 expand, the cushion bubbles 114 included in the fire extinguishing cushion layer 110 of the pad 100 absorb the expansion displacement of the cells 202 while being crushed.

As described above, the cushion bubbles 114 may not only absorb the expansion displacement of the cell 202 but also absorb intense impact from the outside to prevent the impact from being transmitted to the cell 202.

Further, the heat dissipation layer 120 of the pad 100 quickly dissipate heat generated in the cell 202 to the outside of the cell 202.

The heat generated in the cell 202 is quickly discharged to the outside of the quickly cell 202 by the phase change material and the heat dissipation filler included in the heat dissipation layer 120. When the cell 202 is overheated, the fire extinguishing capsules 111 included in the fire extinguishing cushion layer 110 of the pad 100 are destroyed, and the fire extinguishing liquid in the capsule is released, such that a fire in the cell 202 is delayed or suppressed, and the time for which the occupant may escape is ensured.

The heat dissipation cushion fire extinguishing pad for an electric vehicle battery pack according to the present invention described above may effectively dissipate heat generated in the cell of the battery pack and release the fire extinguishing liquid when the cell is overheated, thereby suppressing and delaying a fire and minimizing damage to property and human life.

The technical spirit of the present invention has been described above with reference to the above-mentioned embodiment.

It is apparent that the above-mentioned present embodiment may be variously modified or changed from the disclosure of the present invention by those skilled in the art to which the present invention pertains.

In addition, it is apparent that the technical spirit according to the present invention may be modified in various forms from the disclosure of the present invention by those skilled in the art to which the present invention pertains even though the technical spirit is not explicitly illustrated or described. The modification still belongs to the protection scope of the present invention.

The embodiment described above with reference to the accompanying drawings is disclosed for the purpose of explaining the present invention, and the protection scope of the present invention is not limited to the embodiment.

What is claimed is:

1. A heat dissipation cushion fire extinguishing pad for an electric vehicle battery pack, the heat dissipation cushion fire extinguishing pad comprising:
a fire extinguishing cushion layer in which fire extinguishing capsules each having a capsule filled with a fire extinguishing liquid are mixed; and
heat dissipation layers having a mixed thermally conductive heat dissipation filler and stacked on upper and lower portions of the fire extinguishing cushion layer,
wherein the heat dissipation cushion fire extinguishing pad is inserted between cells of a battery pack, dissipates heat generated in the cell, and releases the fire extinguishing liquid to suppress and delay a fire when the fire occurs.

2. The heat dissipation cushion fire extinguishing pad of claim 1, wherein resin constituting the fire extinguishing cushion layer and the heat dissipation layer is configured by mixing 0.1 to 5 parts by weight of a photoinitiator and 0.1 to 10 parts by weight of a photocuring agent with 100 parts by weight of an acrylate monomer.

3. The heat dissipation cushion fire extinguishing pad of claim 2, wherein resin constituting the heat dissipation layer is configured by further mixing 1 to 50 parts by weight of a viscoelasticity adjusting agent with 100 parts by weight of the acrylate monomer.

4. The heat dissipation cushion fire extinguishing pad of claim 2, wherein in the fire extinguishing cushion layer, 30 to 100 parts by weight of the fire extinguishing capsule are mixed with 100 parts by weight of the resin.

5. The heat dissipation cushion fire extinguishing pad of claim 1, wherein cushion bubbles provided in the form of air bubbles or plastic bubbles filled with air are formed in the fire extinguishing cushion layer.

6. The heat dissipation cushion fire extinguishing pad of claim 5, wherein a volume ratio of the cushion bubbles to the fire extinguishing cushion layer 110 is 1:0.2 to 1.0.

7. The heat dissipation cushion fire extinguishing pad of claim 1, wherein the heat dissipation filler is configured by mixing any one or two or more of aluminum hydroxide {Al(OH)₃}, alumina (Al₂O₃), boron nitride (BN), copper (Cu), aluminum (Al), silver (Ag), carbon fiber, carbon nanotubes (CNTs), graphene, and phase change materials (PCM).

8. The heat dissipation cushion fire extinguishing pad of claim 1, wherein 50 to 1,500 parts by weight of the heat dissipation filler are mixed with 100 parts by weight of the resin of the heat dissipation layer.
